(19) United States
(12) Patent Application Publication
(10) Pub. No.: US 2014/0279662 A1
(43) Pub. Date: Sep. 18, 2014

(54) TRANSPORTATION TIME ESTIMATION BASED ON MULTI-GRANULAR MAPS

(71) Applicants: Heng Wang, Walldorf (DE); Gufei Sun, Shanghai (CN); Wen-Syan Li, Fremont, CA (US)

(72) Inventors: Heng Wang, Walldorf (DE); Gufei Sun, Shanghai (CN); Wen-Syan Li, Fremont, CA (US)

(73) Assignee: SAP AG, Walldorf (DE)

(21) Appl. No.: 13/851,690

(22) Filed: Mar. 27, 2013

(30) Foreign Application Priority Data
Mar. 15, 2013 (CN) 201310084393.4

(51) Int. Cl. G06Q 10/08

(52) U.S. Cl. CPC G06Q 10/0838
USPC 705/338

(57) ABSTRACT

An index engine may receive historical path data characterizing transportation paths in terms of associated conditions, and may define path segments of varying levels of granularity based on the historical path data, wherein relatively shorter path segments have relatively finer levels of granularity than those of path segments of relatively coarser levels of granularity. The index engine may then index each path segment, based on its corresponding level of granularity and its associated conditions. Then, a query processor may receive a query for a new transportation route, and determine a predicted transportation time for the new transportation route, using the indexed path segments.

### CROSS-REFERENCE TO RELATED APPLICATION

This application claims priority under 35 U.S.C. §119 to Chinese Patent Application No. 201310084393.4, filed Mar. 15, 2013, entitled “TRANSPORTATION TIME ESTIMATION BASED ON MULTI-GRANULAR MAPS”, which is incorporated herein by reference in its entirety.

### TECHNICAL FIELD

This description relates to transportation time estimation.

### BACKGROUND

One important aspect of commerce is the transportation of items among different locations. For example, businesses may transport parts to be assembled into a final product for sale from one location to another. Similarly, businesses may transport goods for sale between different portions of a supply chain, e.g., from a factory to a warehouse. In other examples, businesses may wish to deliver goods for sale to consumers thereof.

In these and other transportation scenarios, it is usually important to ensure a timeliness of receipt of the goods being transported. For example, businesses may provide a guarantee of such timeliness as part of a transaction with a consumer or business partner. In other scenarios, a given transportation may be a single leg of a multi-leg supply chain, so that a disruption or delay thereof results in a ripple effect through some or all of the remainder of the supply chain.

Consequently, failure to transport goods in a timely, promised, and/or expected manner may have one or more of a number of potential negative consequences. For example, businesses may experience an immediate loss of profit, such as providing a refund as part of a timeliness guarantee. Further, businesses may experience decreases in efficiency, as well as a loss of reputation.

### SUMMARY

According to one general aspect, a system may include instructions recorded on a computer-readable medium, and executable by at least one processor. The system may include an index engine configured to cause the at least one processor to receive historical path data characterizing transportation paths in terms of associated conditions, the index engine including a segment manager configured to define path segments of varying levels of granularity based on the historical path data, wherein relatively shorter path segments have relatively finer levels of granularity than those of path segments of relatively coarser levels of granularity. The index engine may be further configured to cause the at least one processor to index each path segment, based on its corresponding level of granularity and its associated conditions.

Implementations may include one or more of the following features. For example, the transportation paths may correspond to transportation events within an area and described with respect to a map, wherein the granularity levels are defined with respect to the map.

The granularity levels may correspond to hierarchically-arranged grid elements defined with respect to the map, where grid elements corresponding to a relatively lower, finer granularity level correspond to shorter distances, and are contained within, grid elements corresponding to a relatively higher, coarser granularity level. The associated conditions may characterize corresponding ones of the transportation paths with respect to what existed and/or occurred during corresponding transportation events along the transportation paths.

The indexed path segments may be stored within a path segment index that is searchable with respect to location, granularity level, and associated conditions of each path segment. The index engine may include a parameter extractor configured to analyze the historical path data and determine, with respect to each path segment and associated conditions, parameters that are predictive with respect to a future transportation times of corresponding path segments.

The system may include a query processor configured to cause the at least one processor to receive a query for a new transportation route, and determine a predicted transportation time for the new transportation route, using the indexed path segments. The query may specify the new transportation route by including at least a start and end location defined with respect to a map used to define the path segments.

The query processor may iteratively define the new transportation route in terms of selected ones of the indexed path segments, including an iteration using path segments at a relatively lower, finer granularity level and progressing to a following iteration using path segments at a relatively higher, coarser granularity level, until the new transportation route is finished. The new transportation route may be constructed using matching path segments from the indexed path segments, beginning with a lowest granularity level and progressing to higher granularity levels, and the query processor may determine the predicted transportation time including determining individual, predicted transportation times for each matched path segment and then aggregating the individual, predicted transportation times to obtain the predicted transportation time.

According to another general aspect, a computer-implemented method for executing instructions stored on a computer readable storage medium may include receiving historical path data characterizing transportation paths in terms of associated conditions, defining path segments of varying levels of granularity based on the historical path data, wherein relatively shorter path segments have relatively finer levels of granularity than those of path segments of relatively coarser levels of granularity, and indexing each path segment, based on its corresponding level of granularity and its associated conditions.

Implementations may include one or more of the following features. For example, the method may include receiving a query for a new transportation route, and determining a predicted transportation time for the new transportation route, using the indexed path segments.

The query may specify the new transportation route by including at least a start and end location defined with respect to a map used to define the path segments. Additionally, or alternatively, determining the predicted transportation time may include iteratively defining the new transportation route in terms of selected ones of the indexed path segments, including performing an iteration using path segments at a relatively lower, finer granularity level and progressing to a following iteration using path segments at a relatively higher, coarser granularity level, until the new transportation route is finished. The new transportation route may be constructed using matching path segments from the indexed path segments, beginning with a lowest granularity level and progressing to higher granularity levels, and the predicted transportation time may be determined by determining individual, predicted transportation times for each matched path segment and then aggregating the individual, predicted transportation times to obtain the predicted transportation time.

According to another general aspect, a computer program product tangibly embodied on a computer-readable storage medium may include instructions that, when executed, are configured to receive historical path data characterizing transportation paths in terms of associated conditions, define path segments of varying levels of granularity based on the historical path data, wherein relatively shorter path segments have relatively finer levels of granularity than those of path segments of relatively coarser levels of granularity, and index each path segment, based on its corresponding level of granularity and its associated conditions;

Implementations may include one or more of the following features. For example, the granularity levels may correspond to hierarchically-arranged grid elements defined with respect to a map, where grid elements corresponding to a relatively lower, finer granularity level correspond to shorter distances, and are contained within, grid elements corresponding to a relatively higher, coarser granularity level.

The instructions, when executed, may be further configured to receive a query for a new transportation route, and determine a predicted transportation time for the new transportation route, using the indexed path segments.

The instructions, when executed, may be further configured to determine the predicted transportation time including iteratively defining the new transportation route in terms of selected ones of the indexed path segments, including performing an iteration using path segments at a relatively lower, finer granularity level and progressing to a following iteration using path segments at a relatively higher, coarser granularity level, until the new transportation route is finished. The new transportation route may be constructed using matching path segments from the indexed path segments, beginning with a lowest granularity level and progressing to higher granularity levels, and the predicted transportation time may be determined by determining individual, predicted transportation times for each matched path segment and then aggregating the individual, predicted transportation times to obtain the predicted transportation time.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for transportation time estimation based on multi-granular maps.

FIG. 2 is a map utilized in the system of FIG. 1.

FIG. 3 is a flowchart illustrating example operations of the system of FIG. 1.

FIGS. 4A and 4B are examples of data structures used in the system of FIG. 1.

FIG. 5 is a block diagram of a more detailed example implementation of the system of FIG. 1.

FIG. 6 is a flowchart illustrating example operations of the systems of FIGS. 1 and 5.

FIG. 7 is a flowchart illustrating additional example operations of the systems of FIGS. 1 and 5.

### DETAILED DESCRIPTION

FIG. 1 is a block diagram of a system 100 for transportation time estimation based on multi-granular maps. In the example of FIG. 1, as described in detail below, transportation path data 101 describing many different transportation paths and associated transportation events and conditions may be utilized to determine transportation path segments of varying levels of granularity, where the transportation path segments are indexed for storage and later access. Subsequently, the system 100 may construct a new, requested transportation path, using the transportation path segments of varying levels of granularity, and thereby provide a reliable estimation of a transportation time required for the new, requested transportation path.

In FIG. 1, it is assumed for the sake of the present description that one or more businesses are in the process of continually executing various transportation events, such as those referenced above. However, it may be appreciated that such examples are provided merely for the sake of explanation and illustration, and are not intended to be limiting with respect to the various entities and items that may be associated with such transportation events, nor with respect to characteristics of the transportation events themselves.

For example, in addition to businesses, it may be appreciated that such transportation events may be executed by various other entities, such as, for example, schools, governments, or charitable and other non-profit entities, as well as by private groups or individuals. Consequently, it may be further appreciated that the goods to be transported may include virtually anything that may be relocated from a first position to a second position, including, but not limited to, items for sale, items to be assembled, manufactured, or stored as part of a supply chain, correspondence or other information that is desired to be delivered physically instead of electronically, and/or any other item that may be moved from location to location.

Further, and similarly, many of the examples below are provided with respect to transportation by mode of automotive vehicle, e.g., by car or truck. However, again, such examples are not intended to be limiting. Rather, it will be appreciated that any appropriate mode of transportation may be considered by the system of FIG. 1. For example, such modes of transportation may include transportation by bicycle, walking, airplane, or train. Further, as may be appreciated from the below description, the various modes of transportation may be included as a factor in the transportation time estimation provided by the system 100. For example, in a dense, urban environment, it may or may not be preferable, when possible, to provide delivery by bicycle rather than automobile.

Thus, the path data 101 may be received using one or more of a variety of techniques, and in a variety of forms and formats. For example, during a current transportation of an item, a person involved with the transportation (e.g., a driver of a vehicle) may be responsible for transmitting data associated with the transportation event. In additional or alternative examples, a vehicle may be equipped with technology for transmitting related data associated with the current transportation event. In still other examples, external equipment may be utilized to track the item in transit, such as, e.g., GPS systems, triangulation using wireless transmission towers, and other known location-tracking technologies. Of course, combinations of these and other tracking technologies may be utilized in any desired manner.

Generally speaking, the path data 101 may include virtually any information characterizing the associated transportation event. For example, the path data 101 may include a beginning and end time of the transportation event, as well as various conditions associated therewith. Such conditions may include, e.g., weather information, personnel information (e.g., a driver or other employee), traffic conditions, a nature or characteristic of an item being transported, or of a vehicle used for the transportation, or of any event or occurrence which overlapped in time with the transportation event.

Varying levels of information about each such condition or characteristic may also be included. For example, in addition to exact start/end times, the path data 101 may include information regarding whether the transportation event occurred on a weekend or a weekday, or any particular day of the week. Further, the path data 101 may include higher-level characterizations or categorizations of such information, such as, e.g., whether a transportation event occurred in a time classified as morning, afternoon, evening or night, or whether weather conditions fell into categories of good/neutral/unfavorable.

Of course, the path data 101 also may specify relevant location information associated with the transportation event. For example, the path data 101 may include coordinates characterizing a transportation path followed as part of the transportation event. For example, the path data 101 may include GPS-based coordinates for a start and end position of the transportation path, as well as similar coordinates for intervening points along the transportation path itself. Of course, as referenced herein, various known techniques may be utilized to categorize the transportation path in this regard.

Further, some or all of the path data 101 may be stored in a historical path database 102. In particular, as explained in detail herein, the historical path data 102 may be stored, formatted, and accessed in a manner that is designed to be suitable for interaction with an index engine 104. For example, the received path data 101 may be filtered to remove portions that are not required or desired by index engine 104. Further, the path data 101 may be supplemented or modified, so as to contain data of a certain type, content, and/or form, as specified for subsequent interactions with the index engine 104.

In particular, for example, a transportation path, or portions thereof, may be classified as being associated with a particular level of a plurality of levels of granularity associated with the transportation paths. For example, a particular transportation path, or portion thereof, may be associated with a relatively short distance, about which a relatively large amount of information may be known, and specified within corresponding portions of the path data 101. For example, a short geographical distance may be associated with very precise location coordinates, and/or may be associated with highly detailed information regarding relevant transportation conditions (e.g., traffic conditions). In contrast to such relatively fine levels of granularity, other transportation paths (or portions thereof) may be associated with relatively coarse levels of details, and may be longer and/or may have less precise location coordinates associated therewith.

Thus, the index engine 104 may be configured to manage and store the path data 101 as the historical path data 102. For example, it may be appreciated from the above discussion that the index engine 104 may store some or all of the path data 101 within the historical path data 102, including information related to a relative level of granularity of the stored location information.

Generally speaking, then, the index engine 104 may be configured to utilize the historical path data 102 to construct a path segment index 106. More specifically, as described in detail herein, the index engine 104 may identify, using the historical path data 102, many different discrete path segments, of varying levels of granularity, and associated with various types and quantities of associated information derived from the historical path data 102. In this regard, the path segments stored and indexed using the path segment index 106 may be understood to represent virtually any geographical path that may be derived from the path data 101.

Of course, such path segments may include actual transportation paths from the path data 101. Additionally, or alternatively, and as described in detail below, a particular path segment may be derived from the path data 101, without itself corresponding exactly to a particular path that was actually traveled during the collection of the path data 101. For example, two separate deliveries to two separate locations may overlap, and the overlapping portion may be extracted by the index engine 104 and stored as a path segment within the path segment index 106. In other examples, two separate delivery paths may adjoin, without overlapping, and a single path segment may be constructed utilizing the two adjoining portions of the two delivery paths.

In other words, the path segments referenced with respect to the path segment index 106 need not identify, in a one-to-one correspondence, actual end-to-end delivery or other transportation paths which occurred historically and which were received and stored as such in historical path data 102. Rather, the path segments may refer to overlapping and/or adjoining portions of two or more such historical transportation paths, where, as described herein, such path segments are selected by the index engine 104 as being particularly useful with respect to predicting future transportation times associated therewith. In particular examples, the path segments may correspond to, or be defined in terms of, pre-designated grid elements of a map used to define the original path data 101.

Then, in operation, a query processor 108 may be configured to receive a query 110 which requests a desired transportation route, and to provide in response a predicted, estimated transportation time associated therewith. For example, a user may wish to know approximately how long it will take to transport a package or other item from a first location to a second location. Accordingly, the query processor 108 may proceed to consult the path segment index 106, to thereby construct the transportation route specified by the query 110, on a segment-by-segment basis.

Specifically, as described herein, the query processor 108 may initially attempt to construct the requested transportation route using only path segments at a finest or most detailed level of granularity from within the path segment 106. As may be appreciated, and as described in detail below, such path segments may also be associated with a most-accurate predicted transportation time for traversal thereof. However, such path segments also may not be available for an entirety of the requested transportation route. In such cases, the query processor 108 may proceed to attempt to construct a remainder of the requested transportation route, using a next-highest granularity level for path segments identified using the path segment index 106. The query processor 108 may proceed in this manner until the entirety of the requested transportation route is constructed, and may thereafter aggregate predicted transportation times for each of the path segments of the constructed transportation route, to thereby obtain a total, predicted transportation time for the transportation route.

Further example operations of the index engine 104 are provided with respect to a map 112. For example, the map 112 may represent a map of a city, town, or other location. Of course, the map 112 represents a highly simplified example of a map, which is not drawn to any particular scale, and which is intended merely for the sake of illustration and example.

As shown, in the example of the map 112, locations 114A, 114B represent specific location points. For example, the locations 114A, 114B may represent individual buildings or other street addresses.

Meanwhile, locations 116A, 116B, 116C represent locations represented at a higher level of granularity, i.e., more coarse than a lower level of granularity of the locations 114A, 114B. Similarly, locations 118A, 118B and 118C represent locations represented at a higher, more coarse level of granularity than that of the locations 116A-116C.

As may be appreciated from the above description, the various locations of the map 112 just described may be represented or characterized in a nested fashion, so that locations at lower, more fine levels of granularity are contained within one or more parent levels of relatively higher, coarser granularity. In such scenarios, and in other example implementations, the map 112 may divided into regular, grid-shaped locations. In other example implementations, the map 112 may represent locations of varying levels of granularity in a non-overlapping fashion, and/or may be divided into one or more grids of varying types or shapes.

Thus, the path data 101 may be generated, transmitted, and stored with respect to the map 112, i.e., may be expressed in terms of locations associated with the map 112. For example, as described, many different deliveries or other transportation events may occur within a city represented by the map 112. For example, it may occur that a large number of such deliveries occur between the locations 116A, 116B, and/or between the locations 114A, 114B, and thus within the locations 118A, 118B. Although not illustrated for the sake of simplicity in the example of FIG. 1, it may be appreciated that all such deliveries could be graphically represented within the map 112, and within the confines of various locations thereof just referenced. Meanwhile, it may occur that relatively fewer such deliveries occur within the locations 116C, 118C. Again, such deliveries could be, but are not, represented graphically within the locations 116C, 118C.

Due to the fact that a large number of deliveries occur within the locations 118A, 118B, it may occur that a significant set of such deliveries have transportation paths which partially or completely traverse a route between the locations 114A, 114B. That is, as described, a large number of such paths recorded within the path data 101 may occur at least partially between the locations 114A, 114B, so that the index engine 104 may utilize a path segment 120 to be indexed within the path segment index 106. Since the path segment 120 includes some or all of a large number of overlapping or adjoining portions of paths from within the path data 101, and since a distance between the locations 114A, 114B may be relatively small, the index engine 104 may store the path segment 120 at a relatively fine level of granularity. That is, the path segment 120 may be associated with a large number of detailed conditions or other data that may be useful in predicting a future transportation time that may be experienced when traversing the distance of location 114A to location 114B.

Meanwhile, the relatively sparse nature of delivery events within the location 118C may not allow for the detailed characterization of a path segment at such a relatively fine level of granularity. Instead, a path segment 122 may be defined which is relatively coarse as compared to the path segment 120, and which may be longer and/or otherwise have less predictive value with respect to estimating a transportation time across the location 118C.

Thus, with respect to the map 112, it may be appreciated that the path data 101, and thus the historical path data 102, may represent and/or characterize many different transportation paths and associated transportation events that have occurred within the geographical area represented by the map 112. As referenced above, the index engine 104 may be configured to analyze the resulting historical path data 102, to identify/define and index individual path segments, for storage within the path segment index 106.

More specifically, the index engine 104 may include a segment manager 124, which may be configured to analyze a type and extent of path data associated with individual transportation paths, as well as a nature and extent of overlap between any two or more of the transportation paths, or portions thereof.

For example, as referenced above, the segment manager 124 may identify the path segment 120 as being included within a large number of transportation paths, and associated with a correspondingly large number of transportation conditions associated with each such transportation path. In other words, the path segment 120 may occur within such a plurality of transportation paths, over a wide range of times, dates, days of the week, traffic scenarios, weather events, drivers and other personnel, and many other potentially-related transportation conditions.

Consequently, the segment manager 124 may identify the path segment 120 as occurring at a lowest, finest, and most detailed level of granularity associated with the map 112. Generally speaking, such path segments at this level of granularity may be relatively shorter (i.e., correspond to less distance on the map 112) than path segments at a higher, less detailed, more coarse level of granularity. However, in some example implementations, it may be possible or desirable to permit varying lengths/distances at a given level of granularity. For example, two path segments at a given level of granularity may be adjacent to one another, and could be considered as a single path segment at that granularity level for some purposes.

Similarly, the segment manager 124 may identify the path segment 122 as occurring at a higher, more coarse, less detailed level of granularity. Consequently, and analogously with the path segment 120, the path segment 122 may generally be longer, i.e., represent a longer distance, than the path segment 120. For example, in example implementations in which the map 112 is divided into regular grid structures, such as the location grids 118A, 118B, 118C, the segment manager 124 may automatically, or by default, associate a length of the path segment 122 as corresponding to a width of a corresponding location grid element, e.g., the location grid element 118C.

Thus, the segment manager 124 may utilize an initial set of historical path data 102 to determine a corresponding initial set of path segments. Over time, as new path data 101 is received, the segment manager 124 may update corresponding path segments accordingly. For example, the historical path data 102 may initially contain, for a particular route or distance within the map 112, only enough information for a single, high level path segment. However, as more path data 101 is received, the segment manager 124 may be able to associate a greater quantity and/or extent of relevant conditions with portions of the path segment, and may thereby identify shorter, more detailed path segments therefrom. Conversely, it also may occur over time that the segment manager 124 determines that less or less reliable information is associated with certain path segments. For example, over time, stored travel conditions may become obsolete or outdated, or new data may be received that is in conflict with existing data. In such situations, the segment manager 124 may be configured to correspondingly adjust a granularity level of one or more path segments from a lower/finer level to a higher/coarser level of granularity.

As referenced above, a primary purpose of storing and indexing such path segments is to predict a transportation time or other relevant factors for a future transportation event. In this regard, it may be appreciated that some of the historical path data 102 may have more predictive value than other portions thereof. For example, transportation events which occur along roads heavily used for morning commute traffic will generally be highly predictive of slower transit times for transportation events that occur during those times and along relevant routes. On the other hand, some of the historical path data 102 may have less, or less reliable, predictive value. For example, all things being equal, information that a particular transportation event occurred on a Tuesday, as compared to a Wednesday, may not be particularly valuable or predictive in estimating a future transportation time of a transportation event that occurs on a Tuesday or Wednesday. Moreover, some of the historical path data 102 may be particularly relevant for certain types of transportation events, while not being relevant for other types. For example, traffic conditions may be relevant for transportation events involving automobile delivery, but may be substantially less predictive for transportation events using a bicycle delivery.

In order to consider these and related issues, one or more of a number of known predictive models or algorithms may be constructed for use with the path segments determined by the segment manager 124. Some such models/algorithms are referenced in more detail below, but, in general, such models/algorithms operate by analyzing historical data in an attempt to find information which is highly correlated with desired (or undesired) results or outcomes. Once such factors are identified, subsets of the identified factors may be associated with corresponding weights, in order to reflect, as referenced above, that such factors may have more or less importance in a particular transportation scenario, as compared to a different transportation scenario.

Accordingly, a parameter extractor 126 of the index engine 104 may be configured to analyze path segments constructed by the segment manager 124, in conjunction with relevant travel conditions and other data obtained from corresponding portions of the historical path data 102. Then, the index engine 104 may store the resulting parameters in conjunction with corresponding path segments and relevant travel conditions, within the path segment index 106.

More specifically, the index engine 104 may be configured to construct the path segment index 106 in such a manner that the path segment index 106 is highly and easily searchable by the query processor 108. That is, for example, the query processor 108 should be able to search the path segment index 106 by one or more of a plurality of fields associated with each path segment record stored therein.

For example, the query processor 108 should be able to search the path segment index 106 based on a desired granularity level of a requested path segment. Similarly, the path segment index 106 should be searchable by a location of a desired path segment, or based on specified, relevant travel conditions and/or predictive parameters. Of course, the path segment index 106 should also be indexed so as to be searchable by any combination of the above factors, or other relevant factors.

Thus, in a particular example, the query 110 may be received by the query processor 108 as requesting a transportation time prediction for a transportation event conducted between a start location “A” of the map 112 to an end location “B”, as shown in the map 112. Accordingly, the query processor 108 may consult the path segment index 106 to provide a map 132 with the requested query results. The map 132 is illustrated conceptually in FIG. 1, and provided in detail in FIG. 2.

Thus, speaking generally with respect to FIG. 1, and as referenced above, the query processor 108 may include a segment selector 128 which is configured to search the path segment index 106. Specifically, the segment selector 128 may begin by searching for path segments at a lowest, finest, most detailed level of granularity, which may be relevant in constructing the requested transportation route. Once all such path segments have been identified, the segment selector 128 may proceed to search for path segments at a next-higher granularity level, so that resulting path segments may be utilized to fill in additional portions of the requested transportation route. The segment selector 128 may thus proceed in an iterative fashion, by selecting path segments at each of a next-highest granularity level, until the entire requested transportation route has been constructed, and/or until a highest granularity level has been reached.

Once the requested transportation route has been constructed, a time predictor 130 may be configured to determine a total estimated transportation time for the constructed transportation route. For example, the time predictor 130 may estimate a transportation time for each path segment selected by the segment selector 128, and may then aggregate all such transportation times, to obtain the total estimated transportation time.

In this regard, the time predictor 130 may utilize various parameters stored by the parameter extractor 126 in conjunction with each individual path segment. More specifically, the time predictor 130 may utilize one or more predictive models and related algorithms in order to extrapolate from the selected parameters and thereby determine a predicted transportation time for a corresponding segment.

As referenced, many such models/algorithms exist and may be used in this context. For example, the time predictor 130 may utilize a different model/algorithm for each granularity level, or for different groups of granularity levels. For example, the time predictor 130 may select a particular model/algorithm for a path segment at a lowest, finest level of granularity, where the selected model/algorithm may be particularly suited to take advantage of the relative quantity and type of historical path data that may be associated with such a path segment. Conversely, the time predictor 130 may select a different model/algorithm for path segments at a highest, most coarse level of granularity, where such a selected model/algorithm may be designed to predict a transportation time, even with a relatively scarce amount and type of available transportation data. Of course, it also may occur that the time predictor 130 uses the same predictive model for all path segments in granularity levels.

Thus, the system 100 of FIG. 1 generally may be understood to utilize historical path data 102 for a plurality of actual transportation events, to thereby construct individual path segments, for indexing thereof within the searchable path segment index 106. In this way, a newly requested transportation route may be constructed from the index 106 of path segments, and associated with a predicted transportation time estimated for the completion thereof. In this way, the requested transportation route and associated predicted transportation time may be determined quickly, and with a minimum of computing resources, while nonetheless providing a highly accurate transportation time prediction.

In the example of FIG. 1, the above and other functionalities are provided by the index engine 104 and the query processor 108, as described. In the example of FIG. 1, the index engine 104 and the query processor 108 are illustrated as being executed using at least one computing device 134, which itself comprises at least one processor 134A and computer readable storage medium 134B. For example, executable instructions for executing the index engine 104 and the query processor 108 may be stored using the computer readable storage medium 134B, and may be executed by the at least one processor 134A.

Of course, FIG. 1 is intended merely as a representative, simplified, and non-limiting example(s). In other example implementations, multiple computing devices may be utilized. For example, one or both of the index engine 104 and the query processor 108 may be executed as a remote computing device, while a user of the system 100 inputs the query 110 and views the map 132 by way of a local computing device and associated user interface.

More generally, it may be appreciated that any single component of the system 100 may be executed as two or more subcomponents, perhaps using different computing devices. Conversely, it may be appreciated that any two or more components of the system 100 may be combined for execution as a single component.

Further, it may be appreciated that many additional or alternative components may be included, while one or more of the illustrated components may be omitted in various example implementations. Moreover, many features and functions of the system 100 are not explicitly illustrated in the example of FIG. 1, for the sake of clarity and conciseness. For example, it may be appreciated that the at least one computing device 134 may be associated with various hardware and software elements that are not explicitly illustrated, e.g., various peripherals, displays, power components, and network and other communication interfaces.

FIG. 2 is a more detailed view of a map 132 or FIG. 1. In the example of FIG. 2, as referenced above, the start point “A” and the end point “B” of a requested transportation route are illustrated. In this regard, it may be appreciated that the start and end point A-B are conceptually the same as the corresponding start/end point of the map 112 of FIG. 1. Further, it may be appreciated that the map 112 used to collect historical path data and to perform indexing of path segments may be partially or completely the same as the map 132 utilized for transportation route query processing (although not illustrated as such in the simplified example of FIG. 1).

Thus, as shown, the map 132 may include a number of grid elements, which correspond to locations of varying levels of granularity, as described above with respect to elements 114A, 114B, 116A-116C, and 118A-118C. However, as may be observed from the map 132 of FIG. 2, FIG. 2 illustrates a more detailed and potentially different example than the conceptual examples discussed above with respect to the map 112 of FIG. 1.

Specifically, as shown, the map 132 of FIG. 2 includes grid elements 202 at a highest, least detailed, and most coarse level of granularity. Grid elements 204 represent locations at a somewhat finer, more detailed level of granularity. Finally, grid elements 206 represent, in the example of FIG. 2, a location at a finest, most detailed level of granularity available with respect to the particular example.

Thus, in operation, and in response to the query 110, the query processor 108 (particularly, the segment selector 128) may select path segments associated with grid elements at the level 206, which exist in between the starting point A and the ending point B. In the example, it may occur that grid elements 208 exist and are available for use in the requested transportation route.

However, as also may be observed, the requested transportation route cannot be fully completed through the use of the path segments and corresponding grid elements 208 at the granularity level of the grid element 206. Consequently, the segment selector 128 may proceed to search the path segment index 106 for grid elements and associated path segments at a next/highest level of granularity, i.e., at the level of granularity of the grid element 204. As shown, grid elements 210 correspond to such path segments which exist along the requested transportation route and at the appropriate granularity level.

Finally, the segment selector 124 may determine that the requested transportation route remains incomplete, and therefore may utilize path segments and associated grid elements at the level of the grid element 202, i.e., at a least detailed and most coarse of granularity. As shown, a path segment and associated grid element 212 correspond to the remaining level of granularity, so that the grid element 212 may be inserted to complete the requested transportation route.

Thus, as described above with respect to FIG. 1, the time predictor 130 may proceed to predict transportation times through each of the included grid elements and associated path segments. Then, simply by aggregating all such time predictions, the time predictor 130 may provide a cumulative or complete time estimation for the entirety of the transportation route in question.

As may be appreciated, such predictions of transportation time may generally be expected to be more accurate for path segments and associated grid elements at a level of the grid element 206, and less predictive with respect to path segments and corresponding grid elements at a level of the grid element 202. Nonetheless, in the example of FIG. 2, it may be observed that a majority of the transportation route may be constructed using the path segments at a level of the grid elements 208, while only a relatively few path segments and associated grid elements at the higher levels of granularity (i.e., 210, 212) are necessary to complete the transportation route. Therefore, it may be observed that, in the aggregate, the total estimation of transportation time provided by the time predictor may be accurate and predictive with respect to the requested transportation route. In other words, an impact of the relative lack of predictive value of the grid element and associated path segments at relatively higher levels of granularity may be minimized with respect to the overall transportation time prediction for the transportation route.

FIG. 3 is a flowchart 300 illustrating example operations of the system 100 of FIG. 1. In the example of FIG. 3, operations 302-310 are illustrated as separate, sequential operations. However, in additional or alternative implementations, any two or more of the operations 302-310 may occur in a partially or completely overlapping or parallel manner, or in a nested, iterative, or looped fashion. Moreover, additional or alternative operations may be included, and/or one or more of the operations may be omitted.

In the example of FIG. 3, historical path data characterizing transportation paths in terms of associated conditions may be received (302). For example, as described, the index engine 104 may receive the path data 101, for storage using the historical path database 102.

Define path segments of varying levels of granularity based on the historical path data, wherein relatively shorter path segments have relatively finer levels of granularity than those of path segments of relatively coarser levels of granularity (304). For example, the index engine 104, and specifically, the segment manager 124, may identify various path segments based on transportation paths from within the historical path database 102. As in the example of FIG. 2, the index engine 104 may identify and/or define the path segments with respect to pre-defined grid elements constructed with respect to a relevant map, i.e., a map with respect to which the historical path data has been captured and categorized.

Each path segment may be indexed, based on its corresponding level of granularity and its associated conditions (306). For example, the index engine 104 may construct the path segment index 106 as including the various path segments, where each path segment is stored in conjunction with its individual level of granularity, as well as any associated travel conditions associated therewith.

A query for a new transportation route may be received (308). For example, the query processor 108 may receive the query 110, requesting a transportation route and associated prediction or estimation of transportation time associated therewith and categorized with respect to start/end points A, B.

A predicted transportation time for the new transportation route may be determined, using the indexed path segments (310). For example, the query processor 108 may utilize the searchable path segment index 106 to identify relevant path segments and, in the example of FIG. 2, associated grid elements. As described, the new transportation route may thus be constructed in an iterative fashion, starting with path segments at the lowest level of granularity, to construct as much of the requested transportation route as possible, before moving to path segments at a next-highest level of granularity during a next iteration, and continuing to execute such iterations until the transportation route is fully defined in terms of (e.g., matched to) appropriate/available path segments, and/or a highest, most coarse level of granularity is reached. As described, the resulting transportation route may be utilized to predict a corresponding total transportation time in an accurate, fast, and reliable manner.

FIG. 4A is an example data structure that may be utilized to store location information. As shown, the data structure includes an identifier (ID) field 402, which includes a unique ID used for identifying a location element. For example, the ID may refer to a particular grid element included in the type of grids discussed above with respect to the maps 112, 132, or may refer to a route or portion thereof included in a particular transportation route. In some cases, the ID may refer to a specific location, such as an address, a building name, or a corresponding set of coordinates.

In a field 404, a name for the identified location element may optionally be included. For example, at a lowest granularity level and as just referenced, a location may specify a particular building or a street address, in which case such a building or street address may be associated with a particular name. In other example implementations, the user may be permitted to associate or assign a name to the corresponding unique identifier.

In a field 406, a parent ID of the location element may be stored. As may be appreciated, such a parent ID may refer to a next-higher level of granularity within the hierarchy of granularity levels. A field 408 may include a level of the particular location element, i.e., may specify which granularity level is associated therewith.

Finally, in a field 410, a coordinate for the location element may be stored. For example, as referenced, the coordinates may include GPS coordinates, perhaps specified as latitude/longitude positions.

In practice, it may be appreciated that the data structure of FIG. 4A may be utilized in the historical path database 102. Of course, as referenced above, it may occur that portions of the historical path data 102 and the path segment index 106 may partially overlap, and/or that a single database is utilized to store all relevant data accessed or utilized by the index engine 104 and/or the query processor 108.

FIG. 4B is a second data structure, illustrating an example data structure for preprocessed, indexed path segments. Consequently, as shown, a field 412 may include a start ID field, which includes a unique ID of a start point of a relevant path segment. It may be appreciated that the start ID may include any ID associated with the data structure of FIG. 4A. Similarly, a field 414 includes an end ID field, where the ID of the end point of the path segment, like the start ID, may correspond to any particular ID of the data structure of FIG. 4A.

A field 416 includes a condition field, which stores any and all relevant transportation conditions associated with the path segment in question. Finally, a field 418 corresponds to a parameter field, which stores model parameters for forecasting a transportation time between the start/end points, and under (relevant ones of) the specified conditions.

FIG. 5 is a block diagram which provides a more detailed illustration of example operations of the system 100 of FIG. 1. In the example of FIG. 5, an indexing process 502 is illustrated separately from a subsequent matching process 504, and generally correspond to operations of the index engine 104, and the query processor 108, respectively.

In the example of FIG. 5, as referenced above, techniques for transportation time estimation are described with respect to logistic planning of a business, and, specifically, logistics associated with transportations of items between a warehouse and a destination. In such examples, incorrect time estimations may result in inefficient operations of the business, which may result in problems that extend beyond the simple failure of transporting goods between two points in a timely fashion. For example, such failed or delayed deliveries may result in customer dissatisfaction, and/or may reduce the overall supply chain efficiency.

Conversely, an accurate estimation of transportation time may result in customer satisfaction, as well as a lower cost of inventory and stock. However, as referenced above in detail, and described here with respect to the indexing process 502 of FIG. 5, there are many conditions which may impact a desired transportation time, such as, for example, traffic conditions, road conditions, weather, a date/time of travelling (e.g., weekday versus weekend or Friday night versus Monday morning, or holiday versus workday), where such conditions may be above and beyond estimations associated with an actual distance between the two points and/or a selected route between the two points.

Thus, in the example of FIG. 5, such conditions 505 are illustrated as including time 506, weather 508, path 510, and general conditions 512. As shown, these and other conditions may be considered by an index engine 514, in conjunction with historical path data 502.

In general, the index engine 514 may be understood to be operable to recognize patterns within the historical path data 502 and in conjunction with associated, relevant conditions 505. In other words, the historical path data 502 may be utilized to predict the time needed to travel from one place to another, even though the historical path data 502 may not include individual records for each possible path between each pair of points. Rather, as described, portions of whatever transportation paths are available may be utilized to define/characterize path segments, perhaps in conjunction with corresponding grid elements, as shown and described. Therefore, and advantageously, new transportation routes may be constructed, and associated transportation times may be predicted/estimated, without requiring the storage and/or analysis of all (or even a substantial portion) of available, possible routes between the two points.

In operation, the index engine 514 may utilize one or more relevant map, each divided into discrete location elements, as described above with respect to the various grid elements, and as shown and described with respect to the data structure of FIG. 4A. Thus, a particular path segment may be represented with respect to the map in question, utilizing a series of adjacent location elements. Further, such path segments may be grouped in collections of adjacent location elements, and mapped into a corresponding higher-level location element. For example, as shown in FIG. 2, location elements 206 may be combined to form a single location element 204, which itself may be combined with several other location elements at a same level to result in a larger location element 202. In other words, in the example of FIG. 2, grid elements may be arranged in a hierarchical fashion, so as to thereby construction a multi-granularity map.

Thus, in the example of FIG. 5, the index engine 514 may conduct path segmentation 516, whereby the various path segments are defined in terms of corresponding location elements. Subsequently, model training 518 may be conducted, in order to thereby extract corresponding model/algorithm parameters during a parameter extracting process 520. For example, with respect to the model training 518 and the parameter extracting 520, as referenced above, it may be appreciated that a number of different models and associated algorithms may be used. For example, a branch of time series models may be used, such as, e.g., ARINA, ARNA, and Auto correlation. By selecting and training a particular predictive model, and in accordance with user preferences, the various conditions 505 and other aspects of a particular storage/index path segment may be utilized to construct parameters for storage, e.g., within the parameters field 418 of the data structure of FIG. 4B. The use of such predictive models, by themselves, is generally well known, and therefore not described in greater detail herein, except as may be necessary or helpful in understanding operations of the systems of FIGS. 1 and 5.

As a result of the above-referenced operations, the index engine 514 may construct the path segment index 522. Thus, as described with respect to FIG. 4B and generally herein, a path through a relevant map may be represented as a number of adjacent path segments from within the path segment index, where the path segments themselves are stored as pairs of location elements, so that the overall path constructed also may be considered, in these examples, a series of location elements.

Thus, in the matching process 504, a selected route 524 serves as input to a query processor 526, which, as generally described with respect to the query processor 108, may utilize a segmentation and matching process with respect to the path segment index 522, in order to identify relevant path segments and ultimately determine a total estimated transportation time for the selected transportation route 524.

In the example of FIG. 5, it may occur that the selected transportation route 524 is specified by a user. In other example implementations, however, it may occur that the user merely specifies a start and end point, and the query processor 526 itself constructs details of a corresponding transportation route. In still other example implementations, multiple potential transportation routes may be specified, constructed, or otherwise considered.

In the example of FIG. 5, the query processor 526 receives the selected transportation route 524, and divides the received transportation route 524 into a plurality of segments corresponding to appropriate path segments selected from the path segment index 522. As illustrated with respect to multiple map granularity levels 528, the query processor 526 may first attempt to utilize only path segments at a lowest, finest level of granularity to construct an entirety of the transportation route 524. Then, the query processor 526 may consider each such path segment within the path segment index 532. As referenced above, the query processor 526 may discover that only a subset of these path segments are associated with sufficient historical data to enable a sufficient confidence that a specified level of prediction accuracy may be met. Thus, it may occur that the matching process fails to match the entirety of the selected transportation route 524 with path segments at the lowest, finest granularity level of the level 528.

In such cases in which the matching process misses, the query processor 526 may proceed to attempt to find matching segments in the next-higher level of the levels 528, to thereby attempt to fill in any remaining gaps with respect to the selected transportation route 524. As described and illustrated, the next-higher level has larger grid elements specified therein. Nonetheless, conceptually, the query processor 526 proceeds as just described with respect to the first level of the levels 528; i.e., the query processor 526 identifies intervening path segments and attempts to match these path segments to corresponding path segments and associated historical data within the path segment index 522. As described, this process will continue until the selected transportation route 524 is completed, and/or until a highest, most coarse level of the levels 528 is reached.

Further with respect to FIG. 5, and as referenced above, one or both of the index engine 514 and the query processor 526 may be involved in maintaining, e.g., updating, the path segment index over time. For example, as new path data is received, the existing path data, and corresponding path segments, may become outdated or obsolete. Additionally, new path data may be received which should be added to existing historical path data, in order to provide more accurate transportation time estimations in response to future queries for transportation routes. In particular, it may occur that vehicles associated with a transportation route query may themselves be actively involved in providing new path data, even while following a transportation route provided by the query processor 526. Actual details of processes by which the path segment index 522 is updated or otherwise maintained may generally correspond to the already-described processes for creating the path segment index in the first place, and, therefore, are not separately described here in detail.

FIG. 6 is a flowchart 600 illustrating a more detailed example implementation of an indexing process that may be performed by the index engine 104 of FIG. 1 and/or the index engine 514 of FIG. 5. In the example of FIG. 6, map location elements (e.g., grid elements) and associated granularity levels may be defined (602). For example, such location elements and granularity levels may be set with respect to a map such as the map 112 of FIG. 1. Granularity levels may be defined with respect to distances. For example, a first, lowest level of granularity may be associated with the distance of 100 meters, while the second level may be associated with the distance of 750 meters, and a third level may be associated with a distance of 2000 meters.

Over time, path data may be received (604) with respect to a potentially large number of transportation events. As such path data is received, or at otherwise specified time intervals, historical path data may be updated accordingly (606). For example, the received path data may be processed as needed for storage within the historical path data 102 (e.g., may be processed to match the format of the data structure of FIG. 4A).

Also over time, e.g., continuously or at pre-specified intervals, path segments may be determined between pairs of location elements (608). For example, such path segments may be defined in accordance with the data structure of FIG. 4B. As also described, such path segments may include travel conditions and other relevant data which has been aggregated over a plurality of actual transportation routes which traversed some or all of the corresponding path segment. In this way, such travel conditions for each path segment may be determined (610).

Accordingly, prediction parameters may be determined for each path segment (612), and, again, stored within the data structure of FIG. 4B. For example, as described, such parameters may be determined based on a selected time series model, and in accordance with any additional, relevant user preferences. For example, as described, specified subsets or the stored travel conditions associated with each path segment may have more or less wait in predicting a future transportation time for the path segment in question. Correspondingly, the prediction parameters may determine whether and to what extent any such travel conditions are included for use in predicting future transportation times through the implementation of a time series model, or other predictive model/algorithm.

Finally in FIG. 6, the path segments may be stored in the corresponding path segment index (e.g., the path segment index 106 and/or the path segment index 522) (614). Specifically, the path segments may be stored in association with the corresponding, relevant travel conditions and associated prediction parameters, as described and illustrated with respect to the example data structure of FIG. 4B.

Example pseudo code for the indexing processes of FIG. 6 is provided below:

PSEUDO CODE 1

// Maintain and update Multi-Granular Transportation Historical Time Database
// s: source
// d: destination
// c: condition

| | |
|---|---|
| 1. | FUNCTION addPath(s, d, c) |
| 2. | BEGIN |
| 3. | FOR (i = s : d−1) // i and j are the locations between source s and destination t |
| 4. | FOR (j = s+1 : d) // Line 3 and 4 will enumerate all the segments between s and t |
| 5. | Add the record path(i, j, c) and update the time estimation model for path(i, j) |
| 6. | parent_i = Parent(i) // Try to update the data in the higher level |
| 7. | parent_j = Parent(j) |
| 8. | WHILE it's not the top level |
| 9. | IF (parent_i == parent_j) BREAK |
| 10. | ELSE |
| 11. | Add the record path(parent_i, parent_j, c) and update the time estimation model for |

path(parent_i, parent_j)

| | |
|---|---|
| 12. | END IF |
| 13. | parent_i = Parent(parent_i) |
| 14. | parent_j = Parent(parent_j) |
| 15. | END WHILE |
| 16. | END FOR |
| 17. | END FOR |

FIG. 7 is a flowchart 700 illustrating example query processing operations associated with the example implementations of FIGS. 1 and/or 5. That is, the operations of the flowchart 700 may be understood to be performed by one or both of the query processor 108 and/or the query processor 526.

In the example of FIG. 7, a query is received which specifies at least a source and destination associated with a desired transportation route (702). As referenced above with respect to FIG. 5, the query may, in some example implementations, specify an entirety of one or both desired transportation routes. In another example implementation, only the source and destination may be provided, so that the query processor 108/526 may be responsible for constructing one or more specific transportation routes between the specified start/end point.

In either case, the requested transportation route may first be associated with a lowest-available granularity level (704), corresponding to location elements (e.g., grid elements) of a relevant map which have a shortest length/distance, and which are presumably or potentially associated with a greatest level of detail with respect to a quantity and type of travel condition stored in association therewith.

Then, again in either of these scenarios described above with respect to the operation 702, path segments at the current granularity level may be selected between the specified source and destination (706). That is, in cases where the user specifies only the source and destination, then the query processor 108/526 may be responsible for constructing an actual transportation route there between, and thereafter may determine path segments corresponding to portions thereof. In scenarios in which the entirety of the requested transportation route is provided, the query processor 108/526 will be constrained to selecting path segments which fall along the specified transportation route.

If an entirety of the requested transportation path may not be completed fully at the current granularity level (708), then a next-higher granularity level may be selected (710). That is, if the path segments identified by the query processor 108/526 with respect to the provided or constructed transportation route are not found to have corresponding path segments within the path segment index 106/522, then it will be necessary for the query processor 108/526 to proceed with selection of path segments at the next-higher granularity level (706).

Again, path segments at this current level of granularity will be identified, and considered for potential matches with corresponding path segments within the path segment index 106/522. Again, as long as the match fails for a particular path segment (e.g., due to a non-existence of a corresponding path segment, and/or due to a path segment which is considered to have insufficiently low predictive value as the only available match).

As long as the requested transportation path cannot be completed at the current granularity level (708), then the next-higher granularity level may be selected (710), then the process will continue until the requested transportation path is in fact completed (708). For example, the requested transportation path may be completed at any intermediate granularity level. If however, a highest-granularity level is reached, then the requested transportation path will be completed at that level, even if there is little or no data regarding relevant travel conditions and associated predictive parameters which are associated therewith. In some instances, it may be necessary or desirable to associate a default or standard travel time associated with path segments or location elements at a highest level of granularity, to be used in situations in which little or no associated travel conditions and/or predictive parameters are available.

Finally in FIG. 7, transportation time predictions for each path segment may be aggregated to determine a total transportation time prediction for the requested transportation path (712). As described, a single time series model may be utilized for each path segment. In other example implementations, different prediction models and associated algorithms may be used at each granularity level, in order to reflect the relative levels of available data stored in conjunction with path segments at the varying granularity levels.

Example pseudo code for the query process of FIG. 7 is provided below:

PSEUDO CODE 2

// Multi-Granular Transportation Time Estimation Algorithm
// N: number of segments of the path
// Input is the path, from Point 1 to Point N
// c: condition

| | |
|---|---|
| 1. | FUNCTION EST(Point[1...N], c) |
| 2. | BEGIN |
| 3. | // Recursively segment and match the path |
| 4. | FOR (i = 1 : N−1) |
| 5. | FOR (j = i+1 : N) |
| 6. | IF (exist path(i, j)) // if the path(i, j) exist in historical |
| | database |
| 7. | t1 = EST(Point[1...i], c) // Recursively call for path 1...i |
| 8. | t2 = matchPath(i, j, c) // Find the result based on |
| | historical data |
| 9. | t3 = EST(Point[j...N], c) // Recursively call for path j...N |
| 10. | RETURN t1 + t2 + t3 |
| 11. | END IF |
| 12. | END FOR |
| 13. | END FOR |
| 14. | RETURN EST(Parent(Point[1...N]), c) // if no path is found |
| | in this level, move to up level |
| 15. | END |

### Pseudo Code 2

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a computer-readable medium, and executable by at least one processor, the system comprising:
an index engine configured to cause the at least one processor to receive historical path data characterizing transportation paths in terms of associated conditions, the index engine including
a segment manager configured to define path segments of varying levels of granularity based on the historical path data, wherein relatively shorter path segments have relatively finer levels of granularity than those of path segments of relatively coarser levels of granularity,
the index engine being further configured to cause the at least one processor to index each path segment, based on its corresponding level of granularity and its associated conditions.

2. The system of claim 1, wherein the transportation paths correspond to transportation events within an area and described with respect to a map, and wherein the granularity levels are defined with respect to the map.

3. The system of claim 2, wherein the granularity levels correspond to hierarchically-arranged grid elements defined with respect to the map, where grid elements corresponding to a relatively lower, finer granularity level correspond to shorter distances, and are contained within, grid elements corresponding to a relatively higher, coarser granularity level.

4. The system of claim 1, wherein the associated conditions characterize corresponding ones of the transportation paths with respect to what existed and/or occurred during corresponding transportation events along the transportation paths.

5. The system of claim 1, wherein the indexed path segments are stored within a path segment index that is searchable with respect to location, granularity level, and associated conditions of each path segment.

6. The system of claim 1, wherein the index engine includes a parameter extractor configured to analyze the historical path data and determine, with respect to each path segment and associated conditions, parameters that are predictive with respect to a future transportation times of corresponding path segments.

7. The system of claim 1, comprising:
a query processor configured to cause the at least one processor to receive a query for a new transportation route, and determine a predicted transportation time for the new transportation route, using the indexed path segments.

8. The system of claim 7, wherein the query specifies the new transportation route by including at least a start and end location defined with respect to a map used to define the path segments.

9. The system of claim 7, wherein the query processor iteratively defines the new transportation route in terms of selected ones of the indexed path segments, including an iteration using path segments at a relatively lower, finer granularity level and progressing to a following iteration using path segments at a relatively higher, coarser granularity level, until the new transportation route is finished.

10. The system of claim 7, wherein the new transportation route is constructed using matching path segments from the indexed path segments, beginning with a lowest granularity level and progressing to higher granularity levels, and wherein the query processor determines the predicted transportation time including determining individual, predicted transportation times for each matched path segment and then aggregating the individual, predicted transportation times to obtain the predicted transportation time.

11. A computer-implemented method for executing instructions stored on a computer readable storage medium, the method comprising:
receiving historical path data characterizing transportation paths in terms of associated conditions;
defining path segments of varying levels of granularity based on the historical path data, wherein relatively shorter path segments have relatively finer levels of granularity than those of path segments of relatively coarser levels of granularity; and
indexing each path segment, based on its corresponding level of granularity and its associated conditions.

12. The method of claim 11, further comprising
receiving a query for a new transportation route; and
determining a predicted transportation time for the new transportation route, using the indexed path segments.

13. The method of claim 12, wherein the query specifies the new transportation route by including at least a start and end location defined with respect to a map used to define the path segments.

14. The method of claim 12, wherein determining the predicted transportation time includes iteratively defining the new transportation route in terms of selected ones of the indexed path segments, including performing an iteration using path segments at a relatively lower, finer granularity level and progressing to a following iteration using path segments at a relatively higher, coarser granularity level, until the new transportation route is finished.

15. The method of claim 12, wherein the new transportation route is constructed using matching path segments from the indexed path segments, beginning with a lowest granularity level and progressing to higher granularity levels, and wherein the predicted transportation time is determined by determining individual, predicted transportation times for each matched path segment and then aggregating the individual, predicted transportation times to obtain the predicted transportation time.

16. A computer program product, the computer program product being tangibly embodied on a computer-readable storage medium and comprising instructions that, when executed, are configured to:
receive historical path data characterizing transportation paths in terms of associated conditions;
define path segments of varying levels of granularity based on the historical path data, wherein relatively shorter path segments have relatively finer levels of granularity than those of path segments of relatively coarser levels of granularity; and
index each path segment, based on its corresponding level of granularity and its associated conditions;

17. The computer program product of claim 16, wherein the granularity levels correspond to hierarchically-arranged grid elements defined with respect to a map, where grid elements corresponding to a relatively lower, finer granularity level correspond to shorter distances, and are contained within, grid elements corresponding to a relatively higher, coarser granularity level.

18. The computer program product of claim 16, wherein the instructions, when executed, are further configured to:
receive a query for a new transportation route; and.
determine a predicted transportation time for the new transportation route, using the indexed path segments.

19. The computer program product of claim 18, wherein the instructions, when executed, are further configured to determine the predicted transportation time including iteratively defining the new transportation route in terms of selected ones of the indexed path segments, including performing an iteration using path segments at a relatively lower, finer granularity level and progressing to a following iteration using path segments at a relatively higher, coarser granularity level, until the new transportation route is finished.

20. The computer program product of claim 18, wherein the new transportation route is constructed using matching path segments from the indexed path segments, beginning with a lowest granularity level and progressing to higher granularity levels, and wherein the predicted transportation time is determined by determining individual, predicted transportation times for each matched path segment and then aggregating the individual, predicted transportation times to obtain the predicted transportation time.
